(19) United States
(12) Patent Application Publication
(10) Pub. No.: US 2013/0190552 A1
(43) Pub. Date: Jul. 25, 2013

(54) IMPLANTABLE ACTUATOR FOR HEARING APPLICATIONS

(71) Applicant: Marc Jan Rene Leblans, Kontich (BE)

(72) Inventor: Marc Jan Rene Leblans, Kontich (BE)

(73) Assignee: 3WIN N.V., Niel (BE)

(21) Appl. No.: 13/877,390

(22) PCT Filed: Oct. 7, 2011
(86) PCT No.: PCT/EP2011/067531

§ 371 Date: Apr. 2, 2013

Related U.S. Application Data
(60) Provisional application No. 61/391,415, filed on Oct. 8, 2010.

(30) Foreign Application Priority Data
Oct. 8, 2010 (EP) 10186963.4

(51) Int. Cl. H04R 25/00

(52) U.S. Cl. CPC H04R 25/00
USPC 600/25

(57) ABSTRACT

The invention relates to an electromechanical actuator 100 for hearing applications comprising one or more permanent magnets 10 and one or more magnetically permeable members 20 arranged to form a stator 50 and armature 70 arranged to provide one or more magnetic flux circuits 80, 80′ configured to give rise, in the armature seat 52, to a position of unstable equilibrium for the armature 70 along the longitudinal A-A′ axis and regions either side of the position of unstable equilibrium along the longitudinal A-A′ axis where the armature applies a destabilization-driven force to the compliant member that decreases the effective rigidity of the compliant member that retains to armature in a neutral position. The invention also relates to a hearing aid system incorporating the electromagnetic actuator.

### FIELD OF THE INVENTION

The present invention is in the field of hearing aids, more in particular, implantable actuators operating electromagnetically.

### BACKGROUND TO THE INVENTION

In hearing applications where a linear controllable actuator, i.e. an actuator that produces a force proportional to the applied electric excitation, is needed, there are two main configurations available in the art.

A first possibility is a piezoelectric actuator that can generate a large force, however, its displacement amplitude is limited, in particular when the actuator is miniaturized, meaning it may not provide sufficient mechanical stimulation. Moreover it requires a high driving voltage and a driver providing current control. For miniaturized actuators a driving voltage higher than that of common batteries is needed to obtain displacements in the order of 1 to 10 μm, even when mechanical amplification is used. In principle, battery voltages could be up-converted to some extent, but both the up conversion and the current control require additional electronics with limits in efficiency. This implies additional power consumption of the controller, and as such limits battery lifetime.

Another main possibility is electromagnetic actuation, which is suitable when large displacement amplitudes are needed. An electromagnetic actuator can be used, which is optimized for this purpose at the expense of the force the actuator can generate. Forces required by an actuator must be sufficient not only to displace the relevant hearing structures of the ear, but also to overcome internal forces of the actuator caused by, for example, sealing membranes and rings. Consequently, electromagnetic actuation has also limitations.

The art describes actuators variously in WO 2006/058368 A1, U.S. Pat. No. 7,166,069 B2, U.S. Pat. No. 7,468,028 B2, WO 2006/075169 A1, U.S. Pat. No. 6,162,169, U.S. Pat. No. 5,277,694, U.S. Pat. No. 6,554,762, U.S. 6,855,104 and WO 2008/077943 A2.

The present invention aims to overcome the problems of the art by providing an actuator that is suitable for miniaturization in hearing applications, while providing an adequately large force and displacement for a relatively low power consumption.

### SUMMARY OF THE INVENTION

In view of the foregoing, the present invention relates to a bistable actuator adapted to provide a force proportional to the applied electric excitation. Particular bistable actuators, known in the art, have a central neutral position in which an armature remains in unstable magnetic equilibrium until a current is applied to an integrated coil. An applied current destabilizes the armature, driving it in one direction or the other. Such an actuator has only three positions (neutral, and the two extremes of movement), of which the neutral position is avoided during operation. The limited number of discrete positions is unsuitable for providing a dynamic range to hearing applications.

The present invention provides an electromechanical actuator that is a bistable actuator adapted as a small-stroke controllable actuator, operating near the central neutral position and behaving substantially linearly with respect to both coil current and armature displacement. The force, which tends to drive the armature away from the unstable magnetic equilibrium position, is utilised to advantage within an actuator for a hearing aid, by opposing internal forces of the actuator arising, for example, from the sealing membranes and rings. As a result, the force obtained is much greater than that obtained with the current-induced force alone.

Accordingly, one aspect of the present invention is an electromechanical actuator (100) for hearing applications having a longitudinal shaft (40) in displacement along a longitudinal (A-A′) axis comprising one or more permanent magnets (10) and one or more magnetically permeable members (20) arranged to form a stator (50) and armature (70). The stator (50) provides a seat (52) for receiving the armature (70), the seat (52) configured for longitudinal displacement of the armature (70) along the longitudinal (A-A′) axis relative to the stator (50). According to one aspect, the armature (70) has axial symmetry, and/or a circular, rectangular, elliptical, polygonal transverse profile.

In one feature of the present aspect, one or more compliant members (60) provide a force to said armature (70) to bias the armature (70) in a neutral position between the longitudinal (A-A′) ends of the seat (52). According to one aspect, the compliant member comprises one or more of a diaphragm, a membrane, and a spring bearing. According to another aspect, there are two compliant members comprising a pair of diaphragms (62, 62′), one mounted at each longitudinal (A-A′) end of the actuator, each mechanically connected to the shaft (40), wherein each diaphragm hermetically seals the actuator, and each diaphragm is exposed to ambient pressure.

In another feature of the present aspect, the longitudinal shaft (40) is in rigid attachment to the armature (70).

In another feature of the present aspect, the one or more permanent magnets (10) and one or more magnetically permeable members (20) are arranged to provide one or more magnetic flux circuits in the armature seat (52). The flux circuits are configured to give rise to a position of unstable equilibrium for the armature (70) along the longitudinal (A-A′) axis. The position of unstable equilibrium essentially coincides with said neutral position between the longitudinal (A-A′) ends of the seat (52).

The flux circuits are further configured to give rise to regions either side of the position of unstable equilibrium along the longitudinal (A-A′) axis where the armature applies a destabilisation-driven force to the compliant member that decreases the effective rigidity of the compliant member. In other words, the destablilisation-driven force applied to the compliant member causes a decrease in the effective rigidity of said compliant member. In another feature of the present aspect, the one or more permanent magnets (10) and one or more magnetically permeable members (20) are arranged such that most of the magnetic flux generated by the one or more permanent magnets (10) is distributed over those flux circuits that pass through only one magnet (10). According to one aspect, most of the magnetic flux is greater than 50%, 60%, 70%, 80%, 90%, or 95%, or equal to 100% of total magnetic flux, or a value in the range between any two of the aforementioned values. According to one aspect, there is one permanent magnet (10), and most of the magnetic flux generated by the said permanent magnet (10) is distributed over circuits containing only one magnet. According to another aspect, there are two permanent magnets (10), a first and second magnet, and the sum of:
the magnetic flux generated by the first magnet distributed over circuits containing only the first magnet, and
the magnetic flux generated by the second magnet distributed over circuits containing only the second magnet,
   amounts to most of the total magnetic flux.

According to another aspect, the one or more permanent magnets (10) are disposed in the armature (70) thereby forming a moving magnet actuator. According to another aspect, the one or more permanent magnets (10) of the armature (70) are flanked at each longitudinal (A-A′) end by a magnetically permeable member (20, 20′).

In another feature of the present aspect, one or more coils (30) are incorporated into the stator (50). They are adapted to generate magnetic flux responsive to an electrical signal to modulate the magnetic flux through the armature (70). The modulation of flux generates a current-induced force that displaces the armature (70) from the neutral position against the force of the compliant member (60) whose effective rigidity has been effectively reduced by said destabilization-driven force. In another feature of the present aspect, the armature (70) is displaced by a controllable amplitude dependent on the amplitude of the signal. According to one aspect, the actuator (100) is configured such that the destabilization-driven force and the current-induced force are essentially linear and essentially uncoupled from each other throughout the coil current and armature displacement range of interest.

The actuator described herein may be incorporated into a hearing aid system. One aspect of the invention is a hearing aid system, comprising an actuator described herein.

One aspect of the invention is method for preparing an electromechanical actuator (100) for hearing applications having a longitudinal shaft (40) in displacement along a longitudinal (A-A′) axis comprising the steps:
providing one or more permanent magnets (10) and one or more magnetically permeable members (20, 20′) arranged to form a stator (50) and armature (70), and a seat (52) in the stator (50) for receiving the armature (70) and for displacement of the armature (70) along the longitudinal (A-A′) axis relative to the stator (50),
providing one or more compliant members arranged to provide a force to said armature (70) to bias the armature (70) in a neutral position between the longitudinal (A-A′) ends of the seat (52),
providing a longitudinal shaft (40) in rigid attachment to the armature (70),
   whereby the one or more permanent magnets (10) and magnetically permeable members (20, 20′) are arranged:
   to provide one or more magnetic flux circuits configured to give rise, in the armature seat (52), to:
      a position of unstable equilibrium for the armature (70) along the longitudinal (A-A′) axis,
      regions either side of the position of unstable equilibrium along the longitudinal (A-A′) axis where the armature applies a destabilization-driven force to the compliant member that decreases the effective rigidity of the compliant member,
   such that most of the magnetic flux generated by the one or more permanent magnets (10) is distributed over those flux circuits that pass through only one magnet (10),
providing one or more coils (30) incorporated into the stator (50) adapted to generate magnetic flux responsive to an electrical signal to modulate the magnetic flux through the armature (70), thereby generating a current-induced force that displaces the armature (70) from the neutral position against the force of the compliant member (60) whose effective rigidity has been reduced by said destabilization-driven force, whereby the armature (70) is displaced by a controllable amplitude dependent on the amplitude of the signal.

The displacement dependent destabilizing force becomes substantial when miniaturizing the device, as the displacement induced force follows a lower-power scaling law than the current induced force at constant current density.

The relevant displacements are in the order of 10 μm and the actuator motion is transmitted towards its target (middle or inner ear) through a durable, hermetic enclosure. This implies that the elastic forces that have to be overcome to transmit the actuator vibrations, are much larger than the rest of the load. The destabilizing force, which is available without expenditure of electric power, are used by the instant invention to overcome these elastic forces, allowing a more energy efficient and more compact actuator than with other types of electromagnetic actuators. The destabilizing force gives the instant actuator an advantage with respect to (long-stroke) moving iron controllable actuators, although the current-induced force is similar.

Compared to voice-coil actuators, the present actuator generates a larger current-induced force for a comparable volume and current, is more energy efficient, and has a smaller diameter/length ratio. These are advantageous features from a surgical point of view, as they allow easier miniaturization of the device, and, therefore, allow for access paths to the middle and inner ear, which are not viable otherwise. The lower power consumption results in a longer battery lifetime and less heat dissipation in the human body. With respect to piezoelectric actuators, the present electromagnetic actuator has the advantage that it can be voltage controlled at (or below) common battery voltages when properly designed, which makes the controller electronics simpler and more efficient.

### LEGENDS TO THE FIGURES

FIG. 1 A longitudinal cross-sectional view of an embodiment of an actuator of the invention.

FIG. 2 A longitudinal cross-sectional view of a stator of the embodiment shown in FIG. 1.

FIG. 3 A longitudinal cross-sectional view of an armature of the embodiment shown in FIG. 1.

FIG. 4 A longitudinal cross-sectional view of an alternative configuration, absent of a passageway for a shaft, compared with FIG. 3.

FIG. 5 A longitudinal cross-sectional view of a shaft of the embodiment shown in FIG. 1.

FIG. 6 Graph showing the relationship between displacement and force for the displacement force, the spring load, and the addition of these.

FIG. 7 The actuator shown in FIG. 1, with the principle flux circuits indicated.

FIG. 8 The actuator shown in FIG. 1, with the with additional features referenced.

FIG. 9 A longitudinal cross-sectional view of an actuator of FIG. 1, further provided with a piston and electrical connector on the side.

FIG. 10 A longitudinal cross-sectional view of an actuator of FIG. 1, further provided with a piston and electrical connector on the proximal end.

FIG. 11 A longitudinal cross-sectional view of an alternative embodiment of an actuator of the invention.

FIG. 12 The actuator shown in FIG. 11, with the principle flux circuits indicated.

FIG. 13 A longitudinal cross-sectional view of an alternative embodiment of an actuator of the invention.

FIG. 14 The actuator shown in FIG. 13, with the principle flux circuits indicated.

FIG. 15 A longitudinal cross-sectional view of an alternative embodiment of an actuator of the invention.

FIG. 16 The actuator shown in FIG. 15, with the principle flux circuits indicated.

FIG. 17 depicts a perspective view of configuration of a diaphragm that has an essentially uniform thickness for mounting over one end of the actuator housing of the invention.

FIG. 18A depicts a perspective view of another configuration of a diaphragm of the invention that is thicker at around the periphery of the diaphragm.

FIG. 18B depicts a longitudinal cross-sectional view of the diaphragm of FIG. 18A.

FIG. 19 The actuator shown in FIG. 13, with the flux circuits indicated as contours calculated using a finite element simulation program.

### DETAILED DESCRIPTION OF THE INVENTION

Unless defined otherwise, all technical and scientific terms used herein have the same meaning as is commonly understood by someone skilled in the art. All publications referenced herein are incorporated by reference thereto. All United States patents and patent applications referenced herein are incorporated by reference herein in their entirety including the drawings.

The articles “a” and “an” are used herein to refer to one or to more than one, i.e. to at least one of the grammatical object of the article.

Throughout this application, the term “about” is used to indicate that a value includes the standard deviation of error for the device or method being employed to determine the value.

The recitation of numerical ranges by endpoints includes all integer numbers and, where appropriate, fractions subsumed within that range (e.g. 1 to 5 can include 1, 2, 3, 4 when referring to, for example, a number of elements, and can also include 1.5, 2, 2.75 and 3.80, when referring to, for example, measurements). The recitation of end points also includes the end point values themselves (e.g. from 1.0 to 5.0 includes both 1.0 and 5.0).

The terms “distal” and “proximal” “are used through the specification, and are terms generally understood in the field to mean towards (proximal) or away (distal) from the surgeon side of the apparatus. Thus, “proximal” refers to the end of the actuator that is towards the surgeon side and, therefore, away from the end which applies forces to the ear. Conversely, “distal” means towards the end which applies forces to the ear and, therefore, away from the surgeon side.

In the following detailed description of the invention, reference is made to the accompanying drawings that form a part hereof, and in which are shown by way of illustration only specific embodiments in which the invention may be practiced. It is to be understood that other embodiments may be utilised and structural or logical changes may be made without departing from the scope of the present invention. The following detailed description, therefore, is not to be taken in a limiting sense, and the scope of the present invention is defined by the appended claims.

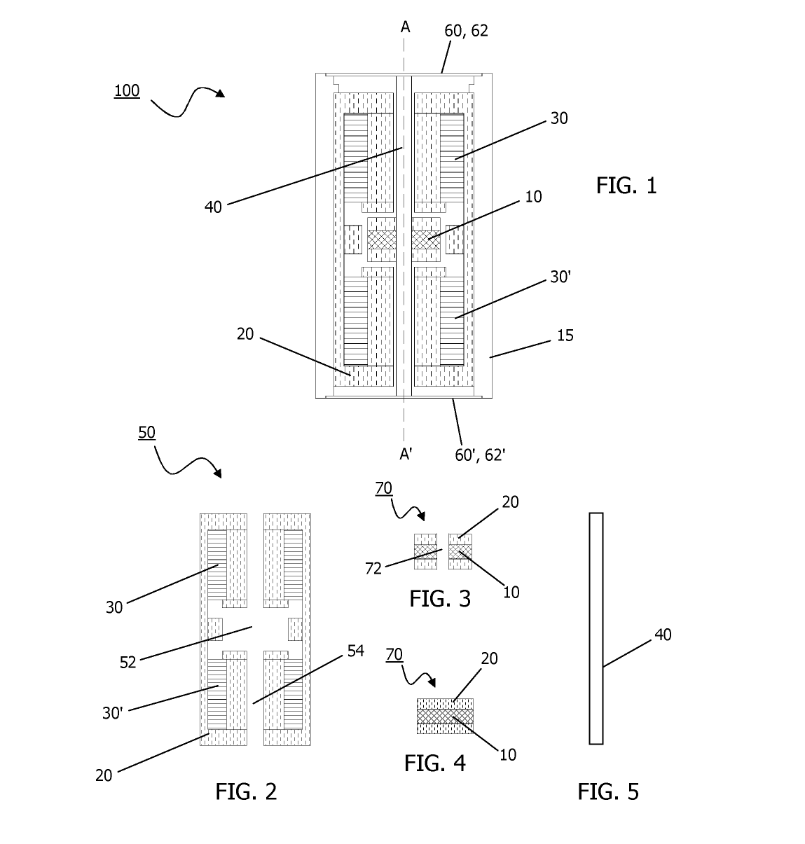

FIGS. 1 to 5 illustrate one example of an electromechanical actuator 100 for hearing applications according to the present invention. FIG. 1 shows the actuator 100 intact with housing 15 and diaphragms 62, 62′, and FIGS. 2 to 5 depict some principle components, namely the stator 50 (FIG. 2), the armature 70 (two different variants FIG. 3 or 4), and shaft (40, FIG. 5). The electromechanical actuator 100 comprises one or more permanent magnets 10 and one or more magnetically permeable members 20 arranged to form a stator 50 and armature 70. In the figures, the permanent magnets 10 have crossed shading, and the magnetically permeable members 20 have vertical shading.

The stator 50 provides a seat 52 for receiving the armature 70, and the seat 52 is configured for displacement of the armature 70 along the (central) longitudinal A-A′ axis relative to the stator 50. One or more compliant members 60, 60′ provide a force to said armature 70 to bias the armature 70 in a neutral position between the longitudinal A-A′ ends of the seat 52. A longitudinal shaft 40 configured for longitudinal displacement along a longitudinal A-A′ axis 40 is in rigid attachment to the armature 70. The longitudinal shaft 40 lies in a passageway 54 formed in the stator 50, parallel or aligned with the longitudinal A-A′ axis of the stator 50.

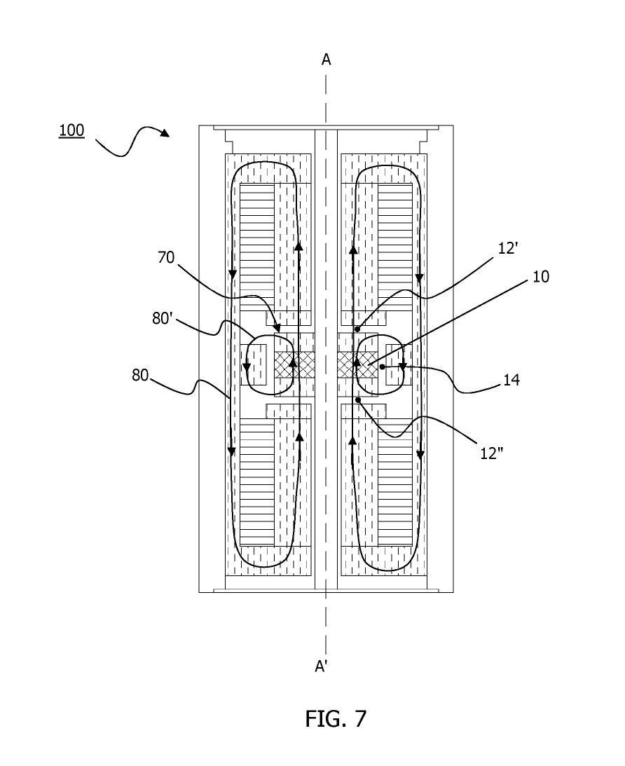

The one or more permanent magnets 10 and one or more magnetically permeable members 20 are arranged to provide one or more magnetic flux circuits 80, 80′. The main flux circuits 80, 80′ generated by the configuration of FIG. 1 are depicted in FIG. 7. Said magnetic flux circuits 80, 80′ are configured to give rise, in the armature seat 52, to a position of unstable equilibrium for the armature 70 along the longitudinal A-A′ axis. Said magnetic flux circuits 80, 80′ are further configured to give rise to regions either side of the position of unstable equilibrium along the longitudinal A-A′ axis where the armature applies a destabilization-driven force to the compliant member that decreases the effective rigidity of the compliant member.

According to one aspect of the invention, the one or more permanent magnets 10 and one or more magnetically permeable members 20 are arranged such that most of the magnetic flux generated by the one or more permanent magnets 10 is distributed over those flux circuits 80, 80′ that pass through only one magnet 10. This condition applies when there is no current flowing through the coil.

One or more coils 30, 30′ are incorporated into the stator 50; in the figures, the coils 30, 30′ have horizontal shading. The coils 30, 30′ are adapted to generate magnetic flux responsive to an electrical signal to modulate the magnetic flux through the armature 70. As a result of the electrical signals, a current-induced force is generated that displaces the armature 70 from the neutral position against the force of the compliant member 60 whose effective rigidity has been reduced by said destabilization-driven force. The armature 70 is displaced by a controllable amplitude dependent on the amplitude of the signal. As shown throughout the figures, the armature 70 and stator 50 may be enclosed in a housing 15. While it is appreciated that a housing 15 may provide a hermetically-sealed enclosure and a biocompatible exterior, the same effects may be achieved using the outermost magnetically permeable members being hermetically sealed and coated with a biocompatible coating.

In the position of unstable equilibrium of the armature, the one or more permanent magnets 10 and one or more magnetically permeable members 20 are arranged so that absent a current being applied to the coil 30, magnetic fields or flux are generated by the magnets that act on the armature 70 in a substantially equal and opposite manner relative to an axis of armature movement, e.g. substantially balanced manner. In this regard, absent current to the coil, the armature 70 remains in a state of static, unstable equilibrium as equal, e.g. in force, and opposite, e.g. in direction, magnetic fields act on the armature 70. The compliant member 60 maintains the armature 70 in the neutral position which essentially coincides with the position of unstable equilibrium of the armature 70.

Once the armature 70 is displaced from the position of unstable equilibrium, i.e. into a region either side of the position of unstable equilibrium, magnetic forces act upon it that tend to move the armature further away from the central position. This force increases with displacement. The relationship between force and displacement may be non-linear or linear. The position of unstable equilibrium is undesired when the actuator is operated as a bistable actuator. In contrast, the present invention uses it in a controllable mode of operation, while avoiding that the armature reaches the latched positions at the end of its travel.

When an electric current flows through the coil, the armature is magnetically attracted to one or other end of the actuator, depending on the direction of the current flowing through the coil. The armature 70, is pulled along the A-A′ axis with increased or decreased force as a function of the amount of current applied to the coil 30. In other words, the armature 70 is disposed for longitudinal movement back and forth along the center axis A-A′ as a function of the current applied to the coil 30.

The actuator 100, however, is configured to exploit the forces arising from destabilization of the armature from the neutral position. Thus, once the current-induced force initiates an armature motion away from the central neutral position, the destabilization-driven force adds to it, enhancing the force on the armature. The destabilization-driven force is substantially linear with displacement of the armature and uncoupled from the current-induced force over the range of interest.

The destabilization driven force applied to the compliant member causes a decrease in its effective rigidity. The destabilization driven force effectively modifies the rigidity of the compliant member which is in contact with the armature. In other words, the rigidity of the compliant member normally causes resistance towards displacement of the armature; owing to the destabilization-driven force, the resistance to displacement of the armature is reduced. Hence the effective rigidity of the compliant member is also reduced.

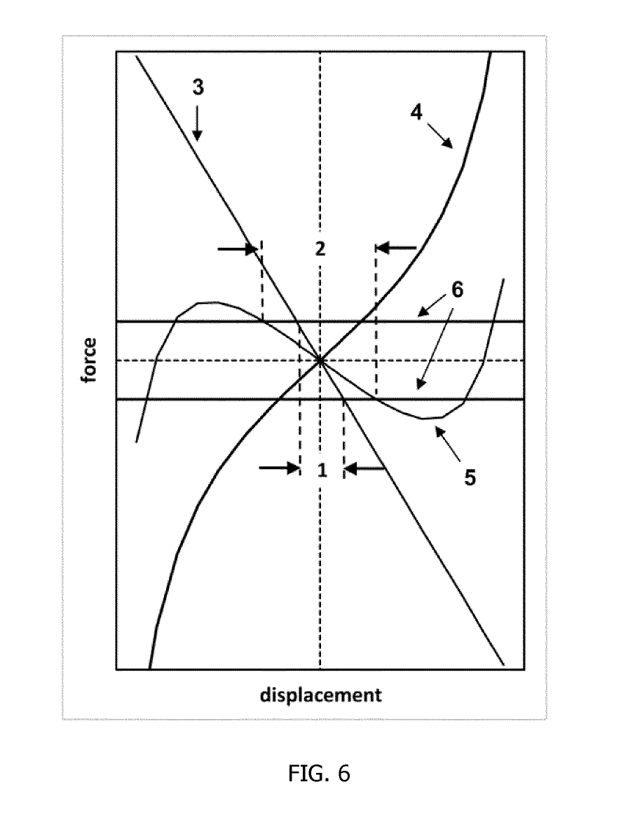

As a result, the actuator is able to drive a larger spring-load than with the current-induced force alone. Alternatively, the additional force can be exploited to increase the displacement for the same spring-loading. This is illustrated in FIG. 6, with the displacement induced force 4, the spring load 3, the superposition 5 of the previous two, the peak values 6 of the current-induced force, the controllable stroke 1 that can be obtained with the current-induced force alone, and the controllable stroke 2 with both components of the force. An AC current through the coil drives an oscillatory motion over the stroke 2. As the slope of curve 5 is less steep than that of the 3, the position sensitive force effectively softens the elastic forces of the spring loading, which also implies that this force may also be used to tune the frequency response of system.

The position sensitive force near the neutral central position, which is small when the device is designed as a bistable actuator, can become substantial depending on the dimensions of components of the actuator. Downsizing the actuator, while keeping the same proportions, favors the displacement sensitive force with respect to the current-induced force because of their different scaling laws.

These features of the actuator make it useful for stimulation of the middle or inner ear in a hearing aid, where miniaturization is crucial. Also, the actuator is loaded by the strong elastic forces of a hermetic, biocompatible enclosure, which make the actuator performance insensitive to external influence, such as atmospheric pressure variation and shock. In view of these requirements, the displacement sensitive force is an additional help to miniaturization, improving energy efficiency and/or increasing of the dynamic range (increased loudness) of the actuator.

Moreover, a smaller design, having a narrower profile facilitates surgical implantation. Certain beneficial access routes to the round window of the cochlear, for example, are hindered by the path of several structures and nerves. An actuator of the invention makes it possible for the first time to take advantage of the narrow surgical channels, previously unavailable, that lead unobstructed to the point of stimulation.

A magnetically permeable member used in an actuator of the invention is made from magnetically conductive material. It provides a path of minimum resistance to magnetic flux generated by a permanent magnet. A magnetically permeable member may be made from any high permeability magnetically conductive material. In one example, a magnetically permeable member may be made from an alloy material having a high saturation flux, such as a Fe/Co/V alloy in the ratios 49/49/2, known in the art as Permendur 2V.

The permanent magnets 10 used in an actuator of the invention provide polarizing flux in the working gaps. The permanent magnets can be made from any suitable magnetic material such as a ferromagnetic or ferrimagnetic material. Alternatively, the permanent magnets 10 may be formed from NdFeB. This is suitable as the actuator is operated at a relatively low temperature and the magnet is enclosed in the protective environment provided by a Titanium housing. The high magnetic flux density NdFeB is capable of providing is an advantage for miniaturization of the actuator.

One or more coils 30, 30′ used in an actuator 100 of the invention are present in the stator 70 to generate magnetic flux responsive to an electrical signal to modulate the magnetic flux through the armature 70. The coil generates a current-induced force that displaces the armature 70 from the neutral position against the force of the compliant member 60. The current-induced force displaces the armature 70 by a controllable amplitude dependent on the amplitude of the signal.

A coil 30, 30′ typically has an annular shape, with a longitudinal axis that is parallel to or co-axial with the longitudinal axis (A-A′) of the actuator. A coil is wound around at least part of the passageway 54 and/or seat 52. As will be appreciated, the number of windings on the coil 30, 30′ is determinative of the strength of the electromagnetic field generated by the coil 30, 30′ when it is energized, as well as the arrangement of the magnetically compliant members. The coil 30, 30′ may be wound such that an alternating current may be applied to the coil 30, 30′ to produce an electromagnetic field normal to the direction of winding along the path 30, 30′. According to this characterization, the direction of flux flow is a function of the direction of an input current applied to the coil 30, 30′. In other words, while the path of the electromagnetic field remains the same, the direction of travel of the magnetic flux may be switched as a function of the direction of the current applied to the coil 30.

One or more compliant members 60, 60′ used in an actuator of the invention provide a force to said armature 70 to bias the armature 70 in a neutral position between the longitudinal A-A′ ends of the seat 52. The effective rigidity of the compliant member 60 is reduced during operation of the actuator by the destabilization-driven forces. A compliant member may be a spring (e.g. helical spring washer or leaf), a diaphragm 62, 62′ or both, disposed at one or both longitudinal ends of the actuator 100.

When the one or more compliant members 60 are diaphragms 62, 62′, they may be employed to hermetically seal the actuator within an hermetic enclosure. The one or more compliant members 60 are sufficiently compliant to deflect with the shaft but stiff enough to resist external influences. They are made from any biocompatible material or coated therewith. For strength, endurance and medium impermeability, the diaphragm material is preferably metallic, being any suitable metal such as surgical steel, platinum, iridium, titanium, gold, silver, nickel, cobalt, tantalum, molybdenum, or their biocompatible alloys. It may alternatively be made from a polymeric substance such as polycarbonate, polypropylene, or poly(tetrafluoroethene) (PTFE). Preferably, it is titanium.

A diaphragm 62, 62′ is thin such that it distorts upon the application of force, but returns to its original shape when the force is removed. The thickness of a diaphragm 62, 62′ in the narrowest region will depend on the desired application, but, for hearing applications, is typically equal to or no more than 2 microns, 5 microns, 10 microns, 15 microns, 20 microns, 40 microns, 50 microns, 100 microns, 150 microns, 200 microns, or a value in the range between any two of the aforementioned values, preferably between 10 microns and 30 microns. The skilled person will understand to adapt the membrane thickness according to the diameter of the membrane, the desired movement, force and the frequency range of the movement as necessary.

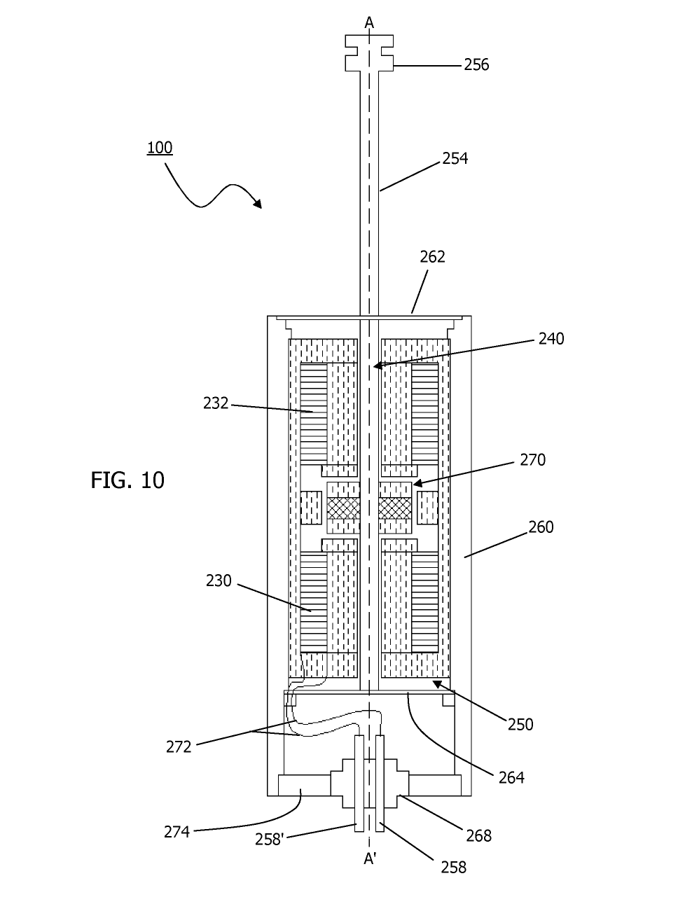

According to one embodiment of the invention, (e.g. FIG. 10) a diaphragm at the proximal end of the actuator is shielded from the outside by an end cap 274 which is less or non-compliant. This allows the feed through of the electric wires from the proximal end of the transducer to be in line with the actuator 100 longitudinal axis. Where the end cap 274 is present, it may perform a sealing function, in which case the diaphragm 264 at the proximal end may be substituted by a spring washer or other bearing means. This offers the possibility to guide electrical wires out through the proximal end of the transducer.

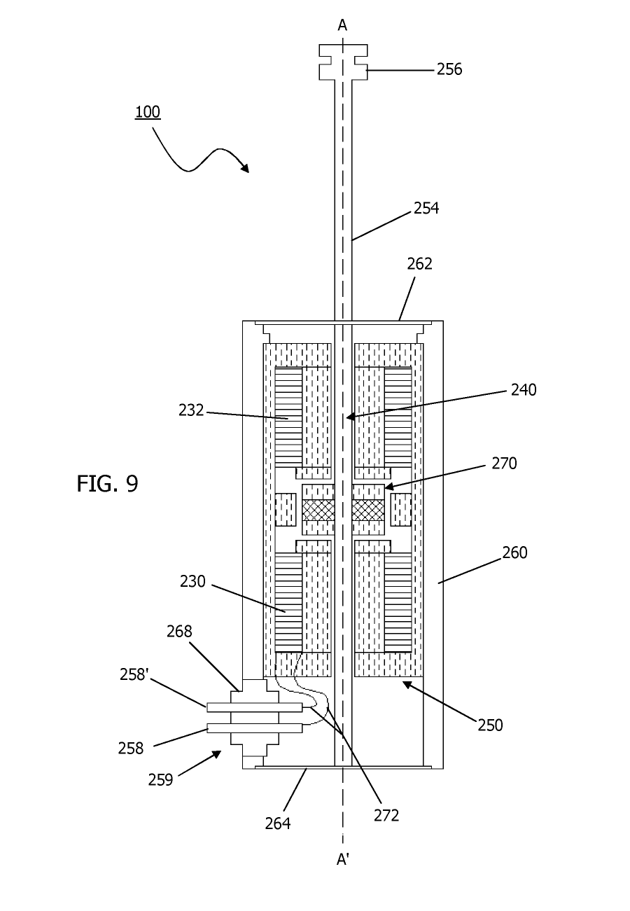

As the actuator is hermetically sealed, the neutral position of the armature shifts under variation of atmospheric pressure, proportional to the compliance of the exposed diaphragm when there is one diaphragm exposed to atmospheric pressure. The design parameters of the diaphragm will, therefore, be determined by a compromise between insensitivity to external conditions, such as ambient pressure variations, compliance to the motion generated by the actuator motor, linear response of the diaphragm, limitation of stress within the deflection range of the diaphragm, and manufacturability. Constraints on the diaphragm may be released to some extent by the arrangement shown, for instance, in FIG. 9, where both diaphragms are exposed to atmospheric pressure. In such an arrangement, the diaphragms will apply, under ambient (external) pressure variations, equal but opposite forces on the armature, as long as their effective areas are the same. This is particularly true in the case of two identical diaphragms. As a result, the rest position of the armature does not change with variations in ambient pressure to which the human body is naturally subjected, for example, at different heights above sea level, in a pressurised aircraft, underwater etc. Due to the stable rest position of the armature, actuator characteristics are not affected. As a consequence, e.g. the displacement range over which the diaphragm and the electromagnetic motor should operate linearly is reduced. Also, unwanted displacement transmission to the middle or inner ear stimulation site is avoided, which contributes to the patient's comfort.

A shaft 40 may be mechanically coupled to the armature 70 directly or indirectly to transfer its movements to the inner or middle ear. Its shape may depend on the target to be activated e.g. ossicles, footplate, round window, or 3rd window. It may be constructed from any material of sufficient rigidity for transmission of vibrations to the target. The material is preferably non-magnetic. The shaft 40 is preferably mechanically coupled to each of the compliant members 60, 60′ (e.g. to each diaphragm 62, 62′). The shaft 40 is preferably in fixed attachment to each of the compliant members 60, 60′ (e.g. to each diaphragm 62, 62′).The shaft 40 may extend through the distal diaphragm terminating in a flat, domed or pointed end, or a piston. Where the shaft terminates within the housing 15, a transmission member may be attached to the exterior side of the distal diaphragm 62, which transfers movements to the inner or middle ear. A transmission member may be rod shaped and may terminate in a flat, domed or pointed end, or in a piston.

The one or more permanent magnets 10 and one or more magnetically permeable members 20 may be arranged to form a stator 50 and armature 70 according to the invention in a plurality of ways. Various armature configurations are illustrated in FIGS. 1, 8 to 11, 13, and 15. The general structures forming the actuator 100 are described below with reference to these drawings, and these separate illustrated exemplary embodiments are described later below in greater detail.

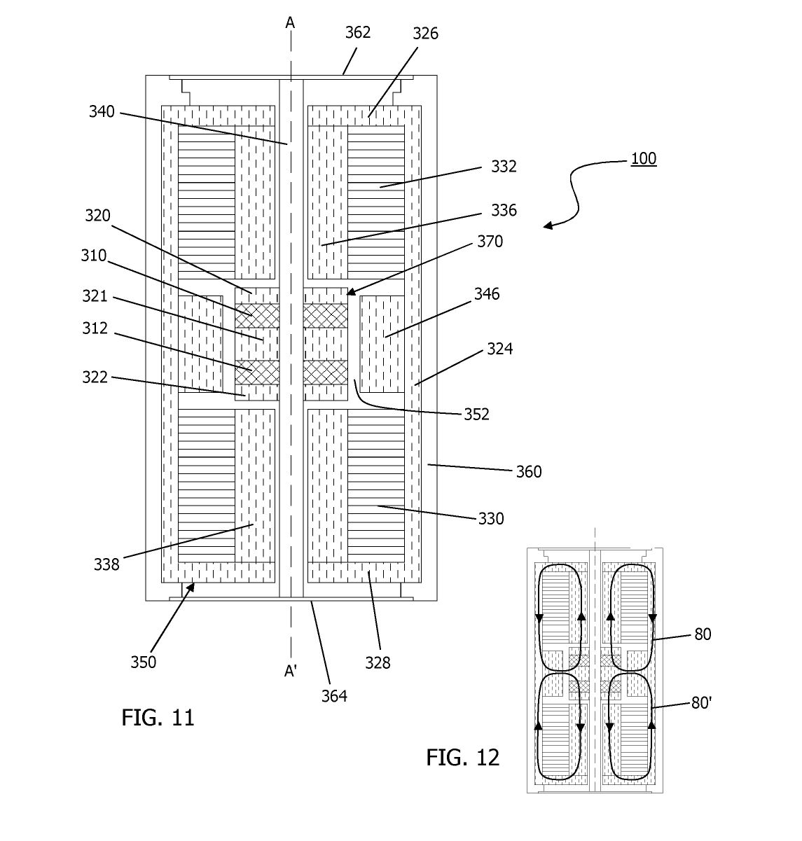

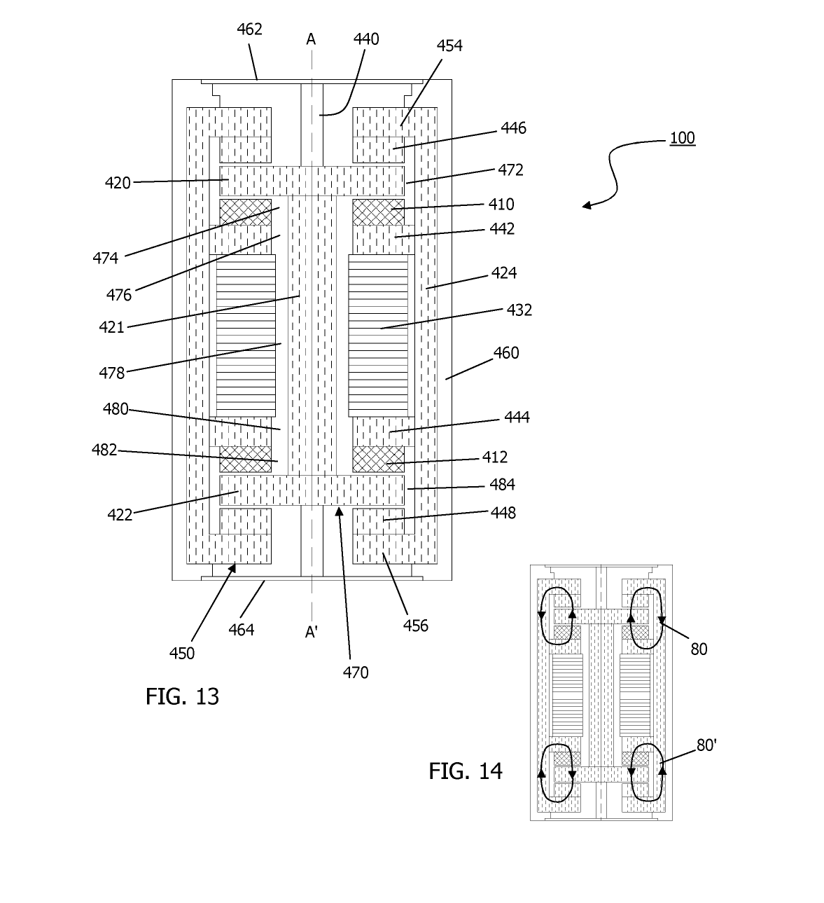

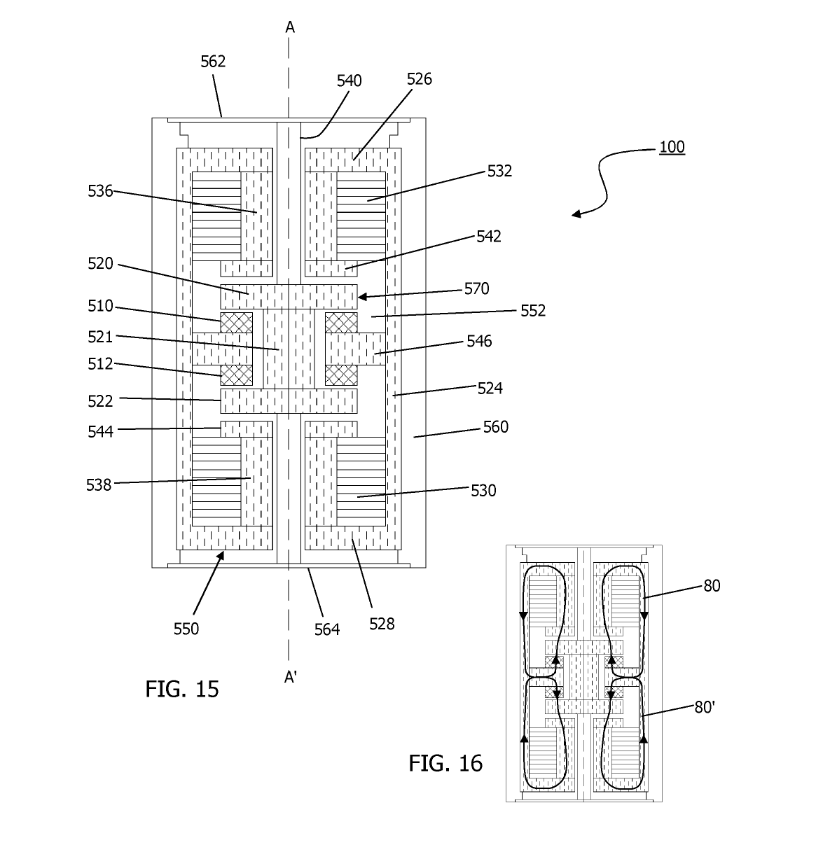

The armature 70 may be formed essentially from one or more magnetically permeable members 20 as shown, for example, in FIGS. 13 and 15. In other words, it may be devoid of any permanent magnets. Alternatively, it may be formed from a combination of one or more magnetically permeable members and one or more permanent magnets 10 as shown, for example, in FIGS. 1, and 8 to 11). Alternatively, it may be formed from one or more permanent magnets 10; it may be devoid of any magnetically permeable members 20. The permanent magnet 10 may be polarized longitudinally or radially, depending on the configuration.

Where there is a combination, one magnetically permeable member 20 may flank each end of the armature 70 in the longitudinal A-A′ direction. When there is one permanent magnet, the magnet 10 may be flanked at each end in the longitudinal A-A′ direction with a magnetically permeable member as shown for example, in FIGS. 1, 8 to 10. When there is more than one permanent magnet, each magnet may be flanked at each end in the longitudinal A-A′ direction with a magnetically permeable member 20 so as to form a stack of alternating permanent magnets 10 and magnetically permeable members 20 as shown for example, in FIG. 11.

The armature 70 generally has a cylindrical shape, more preferably annular. The outer transverse cross-sectional profile i.e. perpendicular to the A-A′ axis, of the armature 70 is preferably circular, however, other shapes are foreseen including rectangular (square or oblong), elliptical, regular or irregular polygonal. The seat 52 of the stator 50 will be adapted to accommodate armature 70 outer shape, providing at the same time a working gap. Working gaps are exemplified in FIG. 7, in which a radial working gap 14 and two longitudinal gaps 12′, 12″ surround the armature 70.

Through the armature 70, in the direction of its longitudinal A-A′ axis, there may be provided a passageway 72, suitable for accommodating the shaft 40. The outer transverse profile i.e. perpendicular to the A-A′ axis, of the passageway 72 is preferably circular, however, other shapes are foreseen including rectangular (square or oblong), elliptical, regular or irregular polygonal. The shaft 40 is adapted to accommodate the shape of the passageway 72 or vice versa.

The longitudinal A′-A cross-sectional outer profile of the armature 70, preferably has a central axis of symmetry along the longitudinal A′-A. One symmetrical half of the profile may have a square “C” shape (e.g. FIGS. 13 and 15).

The stator 50 surrounds the armature 70 around the longitudinal A′-A axis, providing within the stator 50 a seat 52 which is a cavity in which the armature 70 lies and can be displaced along the longitudinal A-A′ axis relative to the stator 50. There is generally a gap around the stator 50 when it lies in the seat 52 to prevent direct contact between the stator 50 and wall of the seat 52. Preferably, the stator 50 and armature 70 are in concentric alignment, the stator 50 being the outer element relative to the inner armature 70.

Through the stator 50, in the direction of its longitudinal A-A′ axis, there may be provided a passageway 54, suitable for accommodating the shaft 40. The outer transverse profile i.e. perpendicular to the A-A′ axis, of the passageway 54 is preferably circular, however, other shapes are foreseen including rectangular (square or oblong), elliptical, regular or irregular polygonal. The shaft 40 is adapted to accommodate the shape of the passageway 54 or vice versa.

The stator 50 is formed essentially from one or more annular coils 30 and one or more annular magnetically permeable members 20, optionally combined with one or more annular permanent magnets 10.

The stator 50 may be formed essentially from one or more magnetically permeable members 20 and one or more annular coils 30 as shown, for example, in FIGS. 1, 8 to 11.

In other words, it may not contain any permanent magnets. Alternatively, it may be formed from a combination of one or more magnetically permeable members 20, one or more annular coils 30 and one or more permanent magnets 10 as shown, for example, in FIGS. 13 and 15.

According to one aspect of the present invention, the one or more permanent magnets 10 and one or more magnetically permeable members 20 are arranged such that most of the magnetic flux generated by the one or more permanent magnets 10 is distributed over those flux circuits that pass through only one magnet 10. In other words, those magnetic flux circuits that pass through only one magnet contain most of the flux distribution. This condition applies when there is no current flowing through the coil. The magnets connected to the armature or the stator are placed such that most of the magnetic flux generated by each magnet is distributed over the flux circuit that passes through the generating magnet alone. It will be appreciated that “only one magnet” implies that there should not be more than one magnet (e.g. not 2, 3, 4 etc) in the circuit, and it is understood that flux circuits will also pass through one or more magnetically permeable members and possibly other elements, the number of which members or other elements is not limited by the present invention.

When most magnetic flux is referred to, it is meant greater than 50%, 60%, 70%, 80%, 90%, or 95%, or equal to 100% of total magnetic flux.

Magnetic flux lines are closed loops that are tangential to the magnetic flux density (B-field) at each of its points and define the circuit(s) followed by the magnetic flux. The skilled person would understand that, after having calculated the magnetic flux density (B-field), one can start to construct flux lines at the surface of the magnet(s), where the B-field points to the outside of the magnet(s), and with a (surface) density proportional to the B-field. Each of these lines are followed, maintaining them tangential to the B-field and until the starting point is reached. As the density of the flux lines is chosen to be proportional to the B-field, each flux line may be considered to carry the same amount of flux. Thus, the fraction or percentage of the magnetic flux that passes through one magnet only can be determined by counting the number of flux lines that pass through 1 magnet, and dividing this by the total number of flux lines.

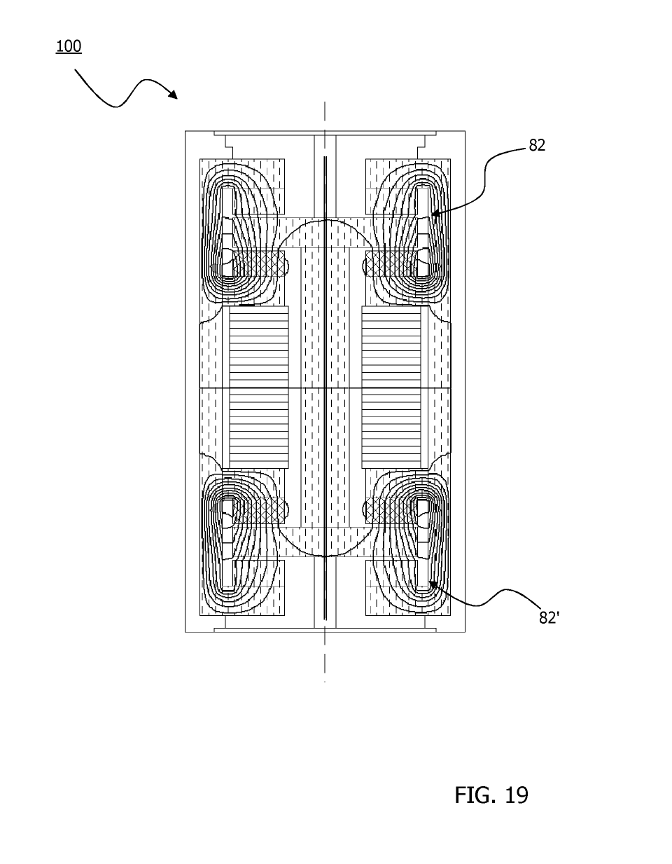

Flux lines can be standardly determined using finite element simulation programs. They visually illustrate magnitude of the B-field for instance as colour maps and/or flux lines, as shown, for instance, in FIG. 19 whereby a set of flux lines (82, 82′) is shown for the actuator of FIG. 13. The lines are a contour plot of the flux function at equidistant values of the flux function. The flux function iv is defined in cylindrical coordinates (z,r, φ) according to Equation [1]

ψ=r A_{φ}(z, r) [Eq. 1]

with the magnetic vector potential A as: B=curl(A).

In the case of the actuator configuration of the present invention, it is not necessary to perform simulations. In the configurations comprising more than 1 magnet, symmetry does not allow flux lines to pass through more than 1 magnet. In the configuration comprising only 1 magnet, it is obvious that flux lines pass through only 1 magnet. The principle flux circuits for several exemplary configurations of the instant invention are illustrated in FIGS. 7, 12, 14 and 16. In FIG. 7, there is essentially one principle flux circuit 80, and one secondary (minor) flux circuit 80′, both circuits having a toroidal shape. In FIGS. 12, 14 and 16, there are essentially two principle flux circuits 80, 80′, each having a toroidal shape. In all cases, each of the flux circuits passes through only one permanent magnet.

When there are two permanent magnets 10, a first and second magnet, the sum of:
the magnetic flux generated by the first magnet distributed over circuits passing only through (containing only) the first magnet (but not the second magnet), and
the magnetic flux generated by the second magnet distributed over circuits passing only through (containing only) the second magnet (but not the first magnet)
   amounts to most of the total magnetic flux.

As mentioned elsewhere, an hermetically sealed enclosure of the actuator causes the neutral position of the armature to shift under variation of atmospheric pressure, proportional to the compliance of the exposed diaphragm when there is one diaphragm exposed to atmospheric pressure. The effect may be alleviated to some extent by employing two diaphragms 62, 62′ each of which is in fixed attachment to the shaft 40, and are exposed to external (ambient) pressure, as shown for instance in FIG. 9. The diaphragms 62, 62′ will apply, under external pressure variations, equal but opposite forces on the armature 70, maintaining its neutral position. The effect is optimal when the effective areas of the diaphragms 62, 62′ are essentially the same.

The use of double diaphragms 62, 62′ is not limited to the actuator described herein, but may be applied to any type of hermetically-sealed actuator. For example, the actuator may contain an electromechanical transducer such as an electromagnetic transducer, electrostatic transducer, magnetostrictive transducer, electrostrictive transducer, a stacked piezo electric assembly, a piezo electric disk bender or a transducer based on differential thermal expansion. The actuator may be configured to operate without the advantages of the destabilization-driven forces. The actuator may be employed in a hearing aid. The double diaphragms 62, 62′ may be coupled using any means, for instance mechanically, as they are in the instant invention. Alternatively, they may be coupled hydrodynamically, by filling the cavity of the actuator with a non-compressible fluid such as a liquid. The result is that the performance characteristics are not affected, either by pressures created as a result of its movements, or by ambient (external) pressures.

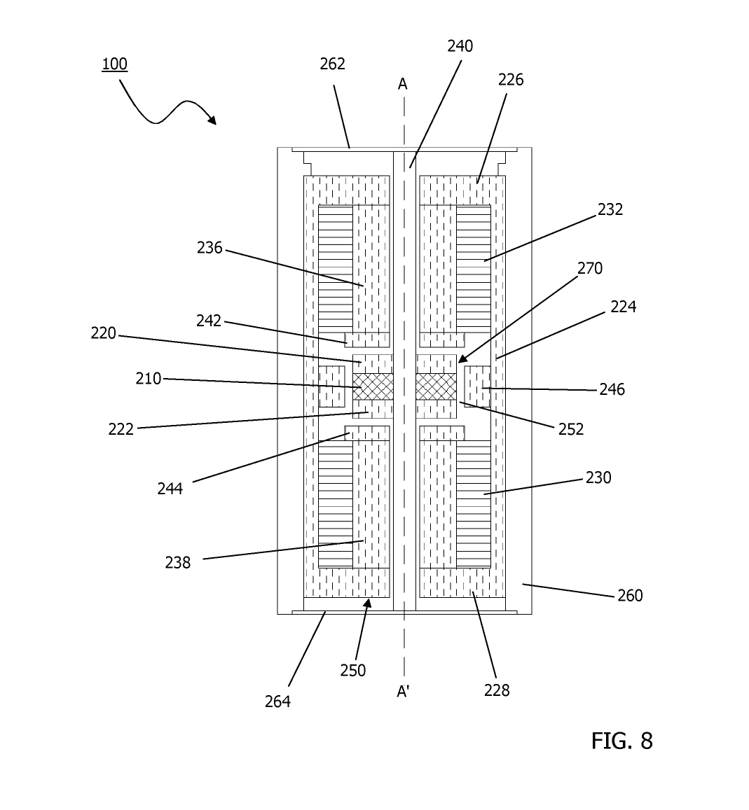

One embodiment of an actuator 100 according to the present invention is depicted in FIG. 8. The armature 70 comprises a main cylindrical component in longitudinal direction formed by a disc-shaped permanent magnet 210 with longitudinal polarization. Optionally, flanking each cylindrical end of the permanent magnet 210 may be a magnetically permeable member 220, 222 formed as a disc. Disposed through the central longitudinal axis of the armature 270 is an elongate member that is the longitudinal shaft 240 having a cylindrical shape. The shaft 240 is in rigid attachment with the permanent magnet 210 and/or the magnetically permeable members 220, 222 of the armature 270.

The stator 250 is formed from a cylindrical body in longitudinal direction, comprising multiple elements. Two hollow cylindrical coils 230, 232 are positioned in co-axial alignment parallel to the longitudinal direction of the stator body. A gap exists between the coils in longitudinal arrangement, in which gap the armature seat 252 lies. Arranged co-axially around the outside of the coils 230, 232 and the gap 252 is an outer cylindrical sleeve 224 of magnetically permeable material; each cylindrical end of the outer cylindrical sleeve is flanked by a flat ring 226, 228 (known as end rings) of magnetically permeable material; each end ring preferably contacts a cylindrical end of one coil 230 or the other coil 232. The outer diameter of the coils 230, 232 and the inner diameter of the cylindrical sleeve 224 are preferably matched, thereby allowing these components to contact each other. Arranged co-axially around the inner cylindrical hollow of each coil 230, 232 and contacting it is an inner cylindrical sleeve 236, 238 of magnetically permeable material. Optionally, the mutually opposing ends of the inner cylindrical sleeves 236, 238 may each provided with a flat ring (known as seat end rings) 242, 244 of magnetically permeable material. The outer diameter of the seat end rings 242, 244 is smaller than that of the coils 230, 232, thus obviating a direct connection with the outer cylindrical sleeve 224. Midway between the longitudinal ends of the seat 252, is disposed a ring 246 (known as a seat central ring) of magnetically permeable material attached to the inner wall of the outer cylindrical sleeve 224. The seat central ring 246 reduces the gap between the armature 270 and the outer cylindrical sleeve 224, resulting in a more efficient flux circuit for the magnetic field generated by the coils.

Arranged co-axially around the outside of the outer cylindrical sleeve is an outer cylindrical housing 260 this may be made from any durable, biocompatible material, e.g. titanium or another biocompatible metal. Each cylindrical end of the outer cylindrical housing 260 is flanked by a circular diaphragm 262, 264 that is mechanically connected to the end of the shaft 240. According to the shown embodiment, the shaft 240 does not pass through the diaphragms, though it will be appreciated that the actuator might be adapted to include this possibility i.e. passage of the shaft 240 through one or both end diaphragms 262, 264 (see later below). The diaphragms 262, 264 seal hermetically the housing 260.

In alternative arrangement (not shown), the housing 260 may be absent, and the exterior of the magnetically permeable members (the outer sleeve 224 and end rings 226, 228) are coated with a biocompatible coating such that the diaphragms are mounted directly onto the outer sleeve 224.

Depicted in FIG. 9 is the actuator of FIG. 8 implemented in a design for a hearing actuator. The longitudinal shaft 240 extends through the distal diaphragm 262 at the distal end of the actuator and terminates in a piston 256. The piston 256 is used to apply mechanical force to the bodily structure e.g. a third window. Also depicted is a coupling 259 for an electrical connector to the coils towards the proximal end of the actuator 100. The coupling 259 comprises a seal 268 against the cylindrical wall of the actuator housing 260 in which two electrical connector pins 258, 258′ are embedded. The pins connect to the coils using electrical wires 272. The proximal diaphragm 264 encloses the electrical coupling 259.

Depicted in FIG. 10 is the actuator of FIG. 8 implemented in another design for a hearing actuator. The longitudinal shaft 240 also extends through the distal diaphragm 262 and terminates in a piston 256. The piston 256 is used to apply mechanical force to the bodily structure. Also depicted is a coupling 259 for an electrical connector to the coils. The coupling is located at the circular proximal end of the actuator 100. The coupling 259 comprises a seal 268 against an end cap of the actuator housing 260 in which two electrical connector pins 258, 258′ are embedded. The pins connect to the coils using electrical wires 272. The coupling is situated proximal to the proximal diaphragm 264; the circular cylindrical end of the housing terminates in an essentially rigid end cap 274 in which the seal 268 for the electrical coupling 259 sits.

Another embodiment of an actuator 100 according to the present invention is depicted in FIG. 11. The armature 370 comprises a main cylindrical component in longitudinal direction formed by two disc-shaped permanent magnets 310, 312 each with longitudinal polarization and three disc-shaped magnetically permeable members 320, 321, 322 arranged (stacked) alternately in the longitudinal direction. The magnets 310, 312 are arranged such that they are polarized in opposite directions. Two of the three magnetically permeable members 320, 322 flank the longitudinal ends of the armature 370. Disposed through the central longitudinal axis of the armature 370 is an elongate member that is the longitudinal shaft 340 having a cylindrical shape. The shaft 340 is in rigid attachment with the permanent magnets 310, 312 and/or the magnetically permeable members 320, 321, 322 of the armature 370.

The stator 350 is formed from a cylindrical body in longitudinal direction, comprising multiple elements. Two hollow cylindrical coils 330, 332 are positioned in co-axial alignment parallel to the longitudinal direction of the stator body. A gap exists between the coils in longitudinal arrangement, in which gap the armature seat 352 lies. Arranged co-axially around the outside of the coils 330, 332 and the gap 352 is an outer cylindrical sleeve 324 of magnetically permeable material; each cylindrical end of the outer cylindrical sleeve is flanked by a flat ring 326, 328 (known as end rings) of magnetically permeable material; each end ring preferably contacts a cylindrical end of one coil 330 or the other coil 332. The outer diameter of the coils 330, 332 and the inner diameter of the cylindrical sleeve 324 are preferably matched, thereby allowing these components to contact each other. Arranged co-axially around the inner cylindrical hollow of each coil 330, 332 and contacting it is an inner cylindrical sleeve 336, 338 of magnetically permeable material.

Midway between the longitudinal ends of the seat 352, is disposed a ring 346 (known as a seat central ring) of magnetically permeable material attached to the inner wall of the outer cylindrical sleeve 324. The seat central ring 346 reduces the gap between the armature 370 and the outer cylindrical sleeve 324.

Arranged co-axially around the outside of the outer cylindrical sleeve is an outer cylindrical housing 360; this may be made from any durable, biocompatible material, e.g. titanium or another biocompatible metal. Each cylindrical end of the outer cylindrical housing 360 is flanked by a circular diaphragm 362, 364 that is mechanically connected to the end of the shaft 340. According to the shown embodiment, the shaft 340 does not pass through the diaphragms, though it will be appreciated that the actuator might be adapted to include this possibility i.e. passage of the shaft 340 through one or both end diaphragms 362, 364. The diaphragms 362, 364 hermetically seal the housing 360.

In alternative arrangement (not shown), the housing 360 may be absent, and the exterior of the magnetically permeable members (the outer sleeve 324 and end rings 326, 328) are coated with a biocompatible coating such that the diaphragms are mounted directly onto the outer sleeve 324.

The one or more variations that include the presence of an elongated shaft, piston, an electrical coupling and end cap depicted in FIGS. 9 and 10 and described elsewhere may optionally be applied to the embodiment described above.

Another embodiment of an actuator 100 according to the present invention is depicted in FIG. 13. The armature 470 comprises a main cylindrical component in longitudinal direction formed by a central cylindrical magnetically permeable member 421 flanked by two disc-shaped magnetically permeable members 420, 422. The diameters of the two disc-shaped magnetically permeable members 420, 422 are the same, and greater than the diameter of the central cylindrical magnetically permeable member 421. A longitudinal cross section of the armature 470 has a capital “I” shape. Extending either side of the armature 470 along the longitudinal axis is an elongate member that is the longitudinal shaft 440 having a cylindrical shape. The shaft 440 is in rigid attachment with one or more of the magnetically permeable members 420, 421, 422 of the armature 470.

The stator 450 is formed from a cylindrical body in longitudinal direction, comprising multiple elements. A hollow cylindrical coil 432 is positioned co-axial to the longitudinal axis of the stator body, and essentially central to the stator body in the longitudinal direction. Adjacent to and contacting each cylindrical end of the coil 432 is a flat ring 442, 444 (known as magnet end rings) of magnetically permeable material. Adjacent to and contacting each magnet end ring 442, 444 in the longitudinal direction moving away from the central coil 432 is a ring-shaped permanent magnet 410, 412, polarized in the longitudinal direction. Adjacent to each ring-shaped permanent magnet 410, 412 in the longitudinal direction moving away from the central coil 432 is a cylindrical gap 472, 484 in which a part of the armature seat is disposed. Each ring shaped magnet 410, 412 has a longitudinal polarization in the opposite directions. Adjacent to each gap 472, 484 in the longitudinal direction moving away from the central coil 432 is a flat ring 446, 448 (known as seat end rings) of magnetically permeable material. Arranged co-axially around the outside of the coil 432, the magnet end rings 442, 444, the ring-shaped permanent magnets 410, 412, the cylindrical gaps 472, 484 and seat end rings 446, 448 is an outer cylindrical sleeve 424 of magnetically permeable material; each cylindrical end of the outer cylindrical sleeve 424 is flanked by a flat ring 454, 456 (known as sleeve end rings) of magnetically permeable material. Each sleeve end ring 454, 456 is adjacent to and contacts a seat end ring 446, 448. The outer diameter of the each magnet end ring 442, 444 matches the internal diameter of the outer cylindrical sleeve 324, thereby connecting these magnetically permeable elements. The outer diameter of the ring-shaped permanent magnets 410, 412, the seat end rings 446, 448 and the coil 432 is less than the internal diameter of the cylindrical housing so that a direct connection of these elements with the sleeve is avoided.

The seat 452 of the stator reciprocates the shape of the armature, and is formed from
the passageway connecting the hollow 478 of the coil 432, the central openings 476, 480 of magnet end rings 442, 444, and the central openings 474, 482 of the ring-shaped permanent magnet 410, 412, and
the cylindrical gap 472.

Accordingly, the seat 452 of the stator 450 has a capital “I” shape profile in longitudinal cross section.

The diameter of the cylindrical gap 472 is greater than that of the passageway. The former accommodates the two disc-shaped magnetically permeable members 420, 422 while the latter accommodates the central cylindrical magnetically permeable member 421. The seat is sized to allow a gap around the body of the seated armature to reduce the effects of friction during actuation.

Arranged co-axially around the outside of the outer cylindrical sleeve is an outer cylindrical housing 460; this may be made from any durable, biocompatible material, e.g. titanium or another biocompatible metal. Each cylindrical end of the outer cylindrical housing 460 is flanked by a circular diaphragm 462, 464 that mechanically contacts the end of the shaft 440. According to the shown embodiment, the shaft 440 does not pass through the diaphragms, though it will be appreciated that the actuator might be adapted to include this possibility i.e. passage of the shaft 440 through one or both end diaphragms 462, 464. The diaphragms 462, 464 hermetically seal the housing 460.

In alternative arrangement (not shown), the housing 460 may be absent, and the exterior of the magnetically permeable members (the outer sleeve 424 and end rings 426, 428) are coated with a biocompatible coating such that the diaphragms are mounted directly onto the outer sleeve 424.

The one or more variations that include the presence of an elongated shaft, piston, an electrical coupling and end cap depicted in FIGS. 9 and 10 and described elsewhere may optionally be applied to the embodiment described above.

Another embodiment of an actuator 100 according to the present invention is depicted in FIG. 15. The armature 570 comprises a main cylindrical component in longitudinal direction formed by a central cylindrical magnetically permeable member 521 flanked by two disc-shaped magnetically permeable members 520, 522. The diameters of the two disc-shaped magnetically permeable members 520, 522 are the same, and greater than the diameter of the central cylindrical magnetically permeable member 521. A longitudinal cross section of the armature 570 has a capital “I” shaped profile. Extending either side of the armature 570 along the longitudinal axis is an elongate member that is the longitudinal shaft 540 having a cylindrical shape. The shaft 540 is in rigid attachment with one or more of the magnetically permeable members 520, 521, 522 of the armature 570.

The stator 550 is formed from a cylindrical body in longitudinal direction, comprising multiple elements. Two hollow cylindrical coils 530, 532 are positioned in co-axial alignment parallel to the longitudinal direction of the stator body. A cylindrical gap exists between the coils in longitudinal arrangement, in which gap the armature seat 552 lies.

Arranged co-axially around the outside of the coils 530, 532 and the gap is an outer cylindrical sleeve 524 of magnetically permeable material; each cylindrical end of the outer cylindrical sleeve 524 is flanked by a flat ring 526, 528 (known as end rings) of magnetically permeable material; each end ring preferably contacts a cylindrical end of one coil 530 or the other coil 532. The outer diameter of the coils 530, 532 and the inner diameter of the cylindrical sleeve 423 are preferably matched, thereby allowing these components to contact each other. Arranged co-axially around the inner cylindrical hollow of each coil 530, 532 and contacting it is an inner cylindrical sleeve 536, 538 of magnetically permeable material. The mutually opposing ends of the inner cylindrical sleeves 536, 538 are each provided with a flat ring (known as seat end rings) 542, 544 of magnetically permeable material. The outer diameter of the seat end rings 542, 544 is smaller than that of the coils 430, 432, thus obviating a direct connection with the outer cylindrical sleeve 224. Midway between the longitudinal ends of the seat 552, is disposed a flat ended ring 546 (known as a seat central ring) of magnetically permeable material attached to the inner wall of the outer cylindrical sleeve 224. The seat central ring 546 is flanked at each side in the longitudinal direction by a ring shaped magnet 510, 512. Each ring shaped magnet 510, 512 has a longitudinal polarization in the opposite directions. The outer diameter of the ring-shaped permanent magnets 510, 512 and the seat end rings 546, 548 are smaller than that of the coils 530, 532, thus obviating a direct connection with the outer cylindrical sleeve 524.

The seat 552 of the stator reciprocates the shape of the armature. Accordingly, the seat 452 of the stator 450 includes a capital “I” shape profile in longitudinal cross section. The seat is sized to allow a gap around the body of the seated armature to reduce the effects of friction during actuation.

Arranged co-axially around the outside of the outer cylindrical sleeve is an outer cylindrical housing 560; this may be made from any durable, biocompatible material, e.g. titanium or another biocompatible metal. Each cylindrical end of the outer cylindrical housing 560 is flanked by a circular diaphragm 562, 564 that is mechanically connected to the end of the shaft 540. According to the shown embodiment, the shaft 540 does not pass through the diaphragms, though it will be appreciated that the actuator might be adapted to include this possibility i.e. passage of the shaft 540 through one or both end diaphragms 562, 564. The diaphragms 562, 564 hermetically seal the housing 560.

In alternative arrangement (not shown), the housing 560 may be absent, and the exterior of the magnetically permeable members (the outer sleeve 524 and end rings 526, 528) are coated with a biocompatible coating such that the diaphragms are mounted directly onto the outer sleeve 524.

The one or more variations that include the presence of an elongated shaft, piston, an electrical coupling and end cap depicted in FIGS. 9 and 10 and described elsewhere may optionally be applied to the embodiment described above.

The actuator 100 of the instant invention may be as such or incorporated into a hearing aid transducer. Typically, the transducer comprises an actuator 100 of the invention which includes the aforementioned housing 15 to prevent damage to the components by exposure to biological liquids, and to protect the human body from contamination by non-biocompatible substances used in the actuator components. The housing 15 is configured for mounting at a fixed position at the implantation site. The housing maintains the stator 50 in rigid alignment. One or both longitudinal ends of the housing 15 may each be provided with a diaphragm 60 that hermetically seal the housing 15. As mentioned above, the diaphragm may act as a compliant member. The housing 15 and diaphragms 62, 62′ may be made of durable, biocompatible material, e.g. titanium or another biocompatible metal. While it is appreciated that a housing 15 may provide a hermetically-sealed enclosure and a biocompatible exterior, the same effects may be achieved using the outermost magnetically permeable members coated with a biocompatible coating. For instance, the permeable sleeve 224 and end rings 226, 228 of FIG. 8 may be coated with a biocompatible coating such that the diaphragms are mounted directly onto the magnetically permeable sleeve 224.

The instant actuator 100 is fully implantable, and may be mounted within the patient's mastoid portion of the facial canal (e.g. via a hole drilled through the skull). A mounting apparatus may be employed; it may be any one of a variety of anchoring systems that permit secure attachment of the transducer in a desired position relative to a desired auditory component, e.g. the round window.

As will be appreciated, the actuator 100 of the present invention may also be employed in conjunction with hearing aid systems that are fully or semi-implantable. In the former, all the other components of the hearing aid system are located subcutaneously, while in a semi-implantable hearing aid system, only some of the components of the hearing aid system are located subcutaneously.

According to one aspect, the hearing aid system comprises a microphone component that may be implantable or externally worn.

According to another aspect, the hearing aid system comprises a speech signal processing (SSP) unit, configured to receive signals from the microphone and to output signals for driving the actuator 100. The SSP unit comprises, for example, processing circuitry and/or a microprocessor, and any communications circuitry. The SSP unit may be implantable or externally worn. During normal operation, acoustic signals are received at the microphone and processed by the SSP unit. As will be appreciated, the SSP unit may utilize digital processing to provide frequency shaping, amplification, compression, and other signal conditioning, including conditioning based on patient-specific fitting parameters. The drive signals cause the actuator 100 to vibrate at acoustic frequencies to effect the desired sound sensation via mechanical stimulation of the oval window, the round window, a third window, or one of the ossicles of the patient.

In a fully implantable system, microphone and SSP unit are all located subcutaneously. Signals between the microphone, SSP unit and actuator are preferably conducted using one or more electrical cables.

According to one embodiment of a semi-implantable system, the microphone is externally worn, and the SSP unit implanted subcutaneously. Signals between the microphone and SSP unit are preferably conducted wireless (e.g. using radio frequency or inductance), however, in the alternative, a transcutaneous connector may be employed. Signals between the SSP unit and actuator are conducted using electrical cables.

According to another embodiment of a semi-implantable system, both the microphone and SSP unit are externally worn. Signals between the microphone and SSP unit are conducted using electrical cables. Signals between the SSP unit and actuator may be conducted wirelessly (e.g. using radio frequency or inductance)—requiring a powered wireless interface operably connected to the actuator. In the alternative, a transcutaneous connector may be employed.

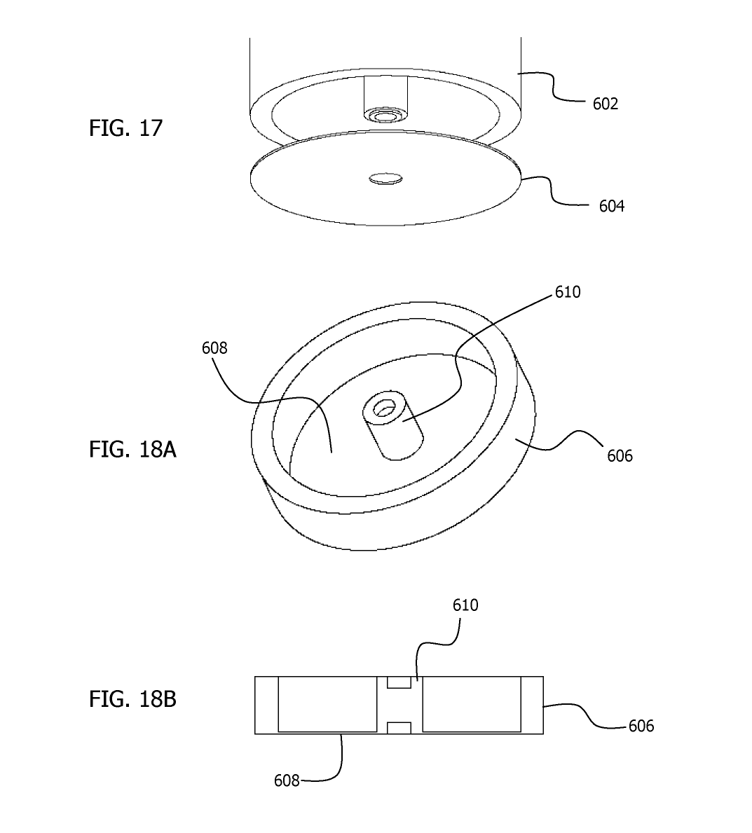

Preparation of an actuator may be performed in a variety of ways. The longitudinal housing 15 provided has an opening at both ends leading to an internal void. The actuator 100 is inserted into the housing void, and the stator 50 rigidly attached to the void wall. Where no housing is employed, the exterior magnetically permeable members are coated with a biocompatible coating. A diaphragm 62, 62′ of thin round foil of titanium, having essentially uniform thickness, may be welded across one opening; an exemplary embodiment is depicted in FIG. 17 where the diaphragm 604 is aligned with the open end of a housing 602 prior to welding. Alternatively, the diaphragm 62, 62′ may be fabricated using a ring having a relative thick outer perimeter provided with a membrane over the ring opening; an exemplary embodiment is depicted in FIGS. 18A and 18B where the ring-like outer perimeter of the diaphragm 606 is thicker than the membrane 608 disposed over the ring opening. At the centre of the membrane 608 is disposed a coupling 610 which aligns and couples with the shaft 40. This type of diaphragm may be prepared by mechanical machining, electrical discharge machining or (DRIE) etching. An optional surface finish treatment (mechanical or electropolish, shot peening, etc) may be used to remove surface structure and stresses at the surface. Welding of the diaphragm to the Titanium enclosure, the piston and the actuator axis is done in this case at the rigid outer ring and the solid center. Therefore, it has less impact on the thin active part of the diaphragm and the residual stresses due to welding are reduced. As the structure is continuous at the center, the welding of the piston and the actuator axis should be mechanically rigid, but hermetic sealing is not a condition any more. These aspects make the diaphragm structure interesting with respect to mechanical performance, lifetime and ease of assembly.

One embodiment of the invention relates to a method for preparing an electromechanical actuator (100) for hearing applications having a longitudinal shaft (40) in displacement along a longitudinal (A-A′) axis comprising the steps:
providing one or more permanent magnets (10) and one or more magnetically permeable members (20, 20′) arranged to form a stator (50) and armature (70), and a a seat (52) in the stator (50) for receiving the armature (70) and for displacement of the armature (70) along the longitudinal (A-A′) axis relative to the stator (50),
providing one or more compliant members arranged to provide a force to said armature (70) to bias the armature (70) in a neutral position between the longitudinal (A-A′) ends of the seat (52),
providing a longitudinal shaft (40) in rigid attachment to the armature (70),
   whereby the one or more permanent magnets (10) and magnetically permeable members (20, 20′) are arranged:
   to provide one or more magnetic flux circuits configured to give rise, in the armature seat (52), to:
      a position of unstable equilibrium for the armature (70) along the longitudinal (A-A′) axis,
      regions either side of the position of unstable equilibrium along the longitudinal (A-A′) axis where the armature applies a destabilization-driven force to the compliant member that decreases the effective rigidity of the compliant member,
   such that most of the magnetic flux generated by the one or more permanent magnets (10) is distributed over those flux circuits that pass through only one magnet (10),
providing one or more coils (30) incorporated into the stator (50) adapted to generate magnetic flux responsive to an electrical signal to modulate the magnetic flux through the armature (70), thereby generating a current-induced force that displaces the armature (70) from the neutral position against the force of the compliant member (60) whose effective rigidity has been reduced by said destabilization-driven force, whereby the armature (70) is displaced by a controllable amplitude dependent on the amplitude of the signal.

It is understood that the armature applies a destabilisation-driven force to the compliant member, which destablilisation-driven force causes a decrease in the effective rigidity of the compliant member. Those skilled in the art will appreciate variations of the above-described embodiments that fall within the scope of the invention. As a result, the invention is not limited to the specific examples and illustrations discussed above, but only by the following claims and their equivalents.

1. An electromechanical actuator for hearing applications having a longitudinal shaft in displacement along a longitudinal axis comprising:
one or more permanent magnets and one or more magnetically permeable members arranged to form a stator and armature,
whereby the stator provides a seat for receiving the armature, the seat configured for displacement of the armature along the longitudinal axis relative to the stator,
one or more compliant members that provides a force to said armature to bias the armature in a neutral position between the longitudinal ends of the seat,
the longitudinal shaft in rigid attachment to the armature,
whereby the one or more permanent magnets and one or more magnetically permeable members are arranged:
to provide one or more magnetic flux circuits configured to give rise, in the armature seat, to:
a position of unstable equilibrium for the armature along the longitudinal axis,
regions either side of the position of unstable equilibrium along the longitudinal axis where the armature applies a destabilization-driven force to the compliant member, which destablilisation-driven force causes a decrease in the effective rigidity of the compliant member, and
such that most of the magnetic flux generated by the one or more permanent magnets is distributed over those flux circuits that pass through only one magnet,
one or more coils incorporated into the stator adapted to generate magnetic flux responsive to an electrical signal to modulate the magnetic flux through the armature, thereby generating a current-induced force that displaces the armature from the neutral position against the force of the compliant member whose effective rigidity has been reduced by said destabilization-driven force, whereby the armature is displaced by a controllable amplitude dependent on the amplitude of the signal.

2. Actuator according to claim 1, wherein said most of the magnetic flux is greater than 50%, 60%, 70%, 80%, 90%, or 95%, or equal to 100% of total magnetic flux, or a value in the range between any two of the aforementioned values.

3. Actuator according to claim 1, wherein there is one permanent magnet, and most of the magnetic flux generated by the said permanent magnet is distributed over circuits containing only one magnet.

4. Actuator according to claim 1, wherein there are two permanent magnets, a first and second magnet, and the sum of:
the magnetic flux generated by the first magnet distributed over circuits containing only the first magnet, and
the magnetic flux generated by the second magnet distributed over circuits containing only the second magnet,
amounts to most of the total magnetic flux.

5. Actuator according to claim 1, whereby the one or more permanent magnets are disposed in the armature thereby forming a moving magnet actuator.

6. Actuator according to claim 5, whereby the one or more permanent magnets of the armature are flanked at each longitudinal end by a magnetically permeable member.

7. Actuator according to claim 1, configured such that the destabilization-driven force and the current-induced force are essentially linear and essentially uncoupled from each other throughout the coil current and armature displacement range of interest.

8. Actuator according to claim 1, wherein the compliant member comprises one or more of a diaphragm, a membrane, and a spring bearing.

9. Actuator according to claim 1, wherein the armature has
axial symmetry, and/or
a circular, rectangular, elliptical, polygonal transverse profile.

10. Actuator according to claim 1, further provided with a housing at least partially enclosing the stator and armature, said housing having axial symmetry, and/or a circular, rectangular, elliptical, polygonal transverse profile.

11. Actuator according to claim 1, wherein there are two compliant members comprising a pair of diaphragms, one mounted at each longitudinal end of the actuator, each mechanically connected to the shaft, wherein each diaphragm hermetically seals the actuator, and each diaphragm is exposed to ambient pressure.

12. Actuator according to claim 1, incorporated into a hearing aid system.

13. A hearing aid system, comprising an actuator according to claim 1.

14. A method for preparing an electromechanical actuator for hearing applications having a longitudinal shaft in displacement along a longitudinal axis comprising the steps:
providing one or more permanent magnets and one or more magnetically permeable members arranged to form a stator and armature, and a seat in the stator for receiving the armature and for displacement of the armature along the longitudinal axis relative to the stator,
providing one or more compliant members arranged to provide a force to said armature to bias the armature in a neutral position between the longitudinal ends of the seat,
providing a longitudinal shaft in rigid attachment to the armature,
whereby the one or more permanent magnets and magnetically permeable members are arranged:
to provide one or more magnetic flux circuits configured to give rise, in the armature seat, to:
a position of unstable equilibrium for the armature along the longitudinal axis,
regions either side of the position of unstable equilibrium along the longitudinal axis where the armature applies a destabilization-driven force to the compliant member, which destablilisation-driven force causes a decrease in the effective rigidity of the compliant member,
such that most of the magnetic flux generated by the one or more permanent magnets is distributed over those flux circuits that pass through only one magnet,
providing one or more coils incorporated into the stator adapted to generate magnetic flux responsive to an electrical signal to modulate the magnetic flux through the armature, thereby generating a current-induced force that displaces the armature from the neutral position against the force of the compliant member whose effective rigidity has been reduced by said destabilization-driven force, whereby the armature is displaced by a controllable amplitude dependent on the amplitude of the signal.
